(19) United States
(12) Patent Application Publication
(10) Pub. No.: US 2023/0311218 A1
(43) Pub. Date: Oct. 5, 2023

(54) MACHINING TOOL COMPRISING A SETTABLE GUIDE RAIL

(71) Applicant: Guehring KG, Albstadt (DE)

(72) Inventor: Klaus MATHEIS, Sauldorf/Rast (DE)

(73) Assignee: Guehring KG, Albstadt (DE)

(21) Appl. No.: 18/180,379

(22) Filed: Mar. 8, 2023

(30) Foreign Application Priority Data
Apr. 5, 2022 (DE) 10 2022 108 098.6

(51) Int. Cl. B23B 39/06; B23B 41/12

(52) U.S. Cl. CPC B23B 39/06; B23B 41/12; B33Y 80/00

(57) ABSTRACT

A machining tool for producing or machining bores, respectively, with high positional and/or surface quality, comprising a tool axis and a tool carrier section, which carries at least one tool blade and at least one guide rail, which radially supports the tool carrier section on a bore wall. The guide rail can be set with respect to its radial position and with respect to its tilt relative to the tool axis by means of a setting means, which engages with a guide rail carrier. In order to put together a tool, which operates highly precisely and with little effort, the guide rail carrier is connected via a material joint to a section that is fixed to the tool, thus either to the tool carrier section or a component, which can be firmly connected thereto, and the material joint can be blocked by means of the setting means.

The invention relates to a machining tool for producing or machining bores, respectively, by means of drills, lathes, machining centers, and other machine tools, in particular for machining bores with a large depth/diameter ratio or with particularly high manufacturing quality or accuracy, respectively, according to the preamble of patent claim 1.

Tools of this kind have, for example, several geometrically defined blades, which, viewed in the circumferential direction of the machining tool, are often provided in uneven distribution in the circumferential surface of the tool. They are additionally provided with at least one guide rail.

Guide rails are often soldered to the carrier body. A drilling tool is described in the document DE 19831920 A1, in the case of which, viewed in the direction of rotation, a guide rail trailing the knife plate is provided, which, together with the knife plate, is fastened to a slide, for example soldered into a groove. This arrangement has the disadvantage that a change or a readjustment of the guide rail is difficult.

According to DE 10 2017 107 249 A1, a guide rail 9 is held in a recess by means of a screw. If it is worn, it can be replaced with a new one. Such a guide rail is predominantly useful for tools, the length of which exceeds approx. 8- to 12-times the tool diameter. However, it can also be used in shorter tools, if particularly high demands are made on the straightness of the bore.

However, guide rails, which are guided in a radially movable manner, are also widely known.

A deep drilling tool, which is equipped with a long shaft, comprising a guide piece, which is flexurally connected to the shaft and which carries at least one guide element, which is guided in a radially resilient manner, on the circumference for abutment on the bore wall, is known from the document DE 25 41 423 A1. In the case of a reamer according to WO 2010/096005 A1, guide pads are also present, which are supported on a groove base via elastically resilient rings, wherein the radially outer stop position thereof is determined by a fixing screw.

U.S. Pat. No. 3,389,621 A1 describes a deep-hole drilling tool comprising a guide rail, which can be pushed radially outwards in abutting contact with the bore wall by means of a coolant/lubricant pressure against the force of a return spring.

WO 2015/165706 A1 shows a design, in the case of which two stationary and at least one radially elastically resilient guide rails are used, wherein the machining tool is elastically pressed against the two stationary guide rails by means of the spring force of the resiliently mounted guide rail during the machining and/or production of a bore.

A drilling tool comprising a guide rail is known from the document DE 2416157 C2, which is mounted in an axial groove of the tool body in an elastically resilient damping material. In the case of the tool according to WO 00/76702 A1, guide rails are also supported radially elastically.

Tools for producing or machining bores, respectively, are also known, in the case of which the guide rails can be set radially.

The document WO 2005/009657 A2 describes, for example, a drill head comprising at least one guide element, which is arranged on its circumference, and comprising at least one cutting insert, which is arranged on the circumference. The guide elements as well as the at least one cutting insert are carried by cassettes, which are dispalceably guided in grooves. To jointly set and calibrate the radial overhang of the at least one guide element as well as of the at least one cutting insert over the circumference of the drill head housing, a setting means is provided, which abuts on the cassettes and the shape of which in the circumferential direction is adapted to the radial distance of the cassettes from the axis of symmetry of the drill head so that the setting and calibration of the overhang of the guide elements and of the at least one cutting insert takes place simultaneously with the fastening of the setting means on the drill head.

Generic tools are known, for example, from the documents DE 2 057 512 A1, DE 43 22 409 C 2, EP 2 331 280 B1, or EP 2 560 778 B1.

DE 2 057 512 A1 shows a drilling tool comprising a guide rail, which is arranged on a pivotably mounted carrier body, so that it can pivot and adapt to the surface of the borehole, whereby a full surface contact is ensured.

A device for machining an outer side 55 of a workpiece, which is coaxial to a geometric longitudinal axis, is known from DE 43 22 409 C 2, in the case of which a cutting head can be put axially over the outer side of the workpiece. A knife plate, the cutting edge of which extends parallel to the geometric longitudinal axis at a first predeterminable radial distance, can be attached to the cutting head. At least one guide surface, which can be slidingly attached to a subregion of the outer side of the workpiece, is arranged on the cutting head. The guide surface is thereby formed on a guide rail, which can be releasably attached to the cutting head (11) and which is mounted on the cutting head so as to be capable of being set in the radial direction with respect to the geometric longitudinal axis (13).

EP 2 331 280 B1 describes a material removing tool comprising a housing body, which has a seating surface for a cutting insert and a guide rail, which can be set in the radial direction between a first radial position and a second radial position, in that a differential pressure is applied to the guide rail.

Lastly, a drill head for a deep drilling tool is described in document EP 2 560 778 B1, which has a blade corner and a first guide rail offset from the blade corner by a guide rail angle measured in the circumferential direction of the drill head, and a second guide rail located diametrically opposite from the blade corner. A setting means for optionally continuously setting a radial distance between its outer abutting zone and the axis of rotation is assigned to at least one of the guide rails.

Increasingly higher demands are made on tools of the above-described type with regard to manufacturing accuracy, service life, and efficiency. Even though it is thus generally possibly to set the guide rails by means of known tools, the setting process is often too time-consuming. In addition, the guide rails are also subject to a wear, so that the tool for resetting the guide rails has to be taken out of production for a significant period of time. Lastly, it has been shown in the case of known tools that the fine-setting of the guide rails becomes all the more inaccurate, the more stable the fastening of the guide rails is designed.

It is thus the object of the invention to provide a generic tool, in the case of which the guide rail can be brought into an optimal position more quickly and more accurately in response to a stable fixation on the tool carrier section and can be calibrated exactly in the case of wear. A further object is to be seen in providing a cassette for such a tool, by means of which it is possible to assemble a tool, which operates highly precisely, comprising at least one guide rail, which can be brought into an optimal position quickly and accurately and which can be calibrated exactly in the case of wear, with as little effort as possible.

The object is solved by means of a machining tool comprising the features of patent claim 1 or by means of a cassette comprising the features of patent claim 14, respectively. Advantageous further developments are subject matter of the subclaims.

The special feature of the tool is to be seen in the way the guide rail can be set with respect to its position and alignment to the tool axis or to a reference surface of a cassette supporting the guide rail, respectively. The guide rail thereby sits firmly on a guide rail carrier, which is connected to a section that is fixed to the tool via a material joint. The guide rail carrier is thereby routinely formed to be stiffer than the material joint, so that the guide rail carrier is not subject to any noteworthy deformation in response to elastic deformation of the material joint. Due to the fact that the material joint can be blocked by means of the setting means, the setting means has a dual function. It ensures a play-free settability in the micrometer range and simultaneously stabilizes the articulated connection of the guide rail carrier, so that the guide rail can safely introduce the support forces acting on it into the tool body or the cassette, respectively, via the guide rail carrier and by cooperation of material joint and setting means. According to this arrangement, the guide rail carrier is quasi floatingly articulated in a radial plane on the section that is fixed to the tool but is positionally fixed by means of the setting means. This results in the additional advantage that the joint, which allows for the settability of the guide rail, is not subject to a contamination, so that it operates reliably over a long period of time and also under extreme operating conditions with aggressive coolants/lubricants. The arrangement is thereby preferably made so that the material joint leaves a uniaxial main degree of freedom of movement for the guide rail carrier, whereby the connection of the guide rail carrier gains stability.

According to an advantageous further development, the setting means has at least one setting member, the length of which can be changed or set, respectively, and which is formed in a rod-like manner. The setting member is thereby preferably positioned and aligned so that it can introduce the support forces acting on the guide rail into the tool or into a cassette that is fixed to the tool, respectively, in the manner of a push rod, so that the material joint is largely relieved of these forces. Due to the fact that the setting member, in connection with the material joint, fixes the guide rail carrier to the tool carrier section in a shear-resistant and tension-resistant manner, no fastening means has to be released to reset or adjust the guide rail, respectively, whereby the setting or resetting movement, respectively, can be performed more accurately and more quickly. Due to the fact that the guide rail carrier only has to be movable in one radial plane in order to set or reset of the guide rail, respectively, the at least one setting member only has to absorb the radial support forces. Forces in the circumferential direction can be absorbed by means of a flat support of the guide rail carrier on a component that is fixed to the tool.

When the setting means is connected between the guide rail carrier and a component of the tool, which is spatially fixed or fixable, respectively, with respect to the tool carrier section, a particularly resistant, i.e. deformation-resistant, blockage of the material joint results.

The material joint is advantageously designed in such a way that it allows for an essentially radial displacement movement and a pivoting movement of the guide rail carrier with respect to the tool carrier section about an axis, which is essentially perpendicular to a radial plane containing the guide rail and the tool axis. This design makes it possible to use the degree of freedom of the joint not only for radially adjusting the guide rail, but also for setting the tilt with respect to the tool axis. The guide rail can be subjected in the simplest way to an ultra-fine resetting in this way, if an uneven wear should appear over the length of the guide rail. A directed movability is simultaneously given to the material joint. The forces, which are to be transferred by the setting means, for locking or blocking the material joint, respectively, can thus likewise be limited to one plane.

If at least two setting members are provided for blocking the material joint, which lie on different sides of the joint axis, the setting members can be used to tension the blockage of the material joint, i.e. to stabilize it additionally and without play. In this case, the material joint permits the guide rail carrier to perform a tilting movement about the material joint axis similar to a rocker, whereby it is also possible to set and reset the tilt of the guide rail carrier to the tool axis without play.

The at least one setting member advantageously has a setting screw, which can preferably be accessed radially or on the front side, which is supported on the section that is fixed to the tool on the one hand and which is in threaded engagement with the guide rail carrier on the other hand. Such a setting member is constructed simply and, in the case of corresponding selection of the thread pitch, allows for the provision of a sufficiently small transmission between the setting-rotational movement of the setting screw and the displacement movement of the guide rail carrier induced thereby, so that a fine setting of the guide rail in the micrometer or arcminute range, respectively, is made possible even with setting screws with a small diameter.

This further development simultaneously creates the precondition that an accurate assignment between the drive movement of the setting screw and the adjustment path of the guide rail, which is caused thereby, is specified. An accurately specified radial displacement of the guide rail carrier in the micrometer range, for example of 5 μm, can thus be provided for a certain rotational movement of the setting screw, of, for example, 90°.

If the setting screw is formed by a differential threaded screw, which has two threaded sections of different pitch and/or different thread direction, a first threaded section of which engages with the guide rail carrier and a second threaded section of which engages with a nut, which can preferably be inserted from the outside and which is caught in a non-displaceable manner in a slit-like recess, the gear transmission ratio between rotational movement of the setting screw and displacement movement of the guide rail can be influenced with simple means.

It is generally possible to directly connect the guide rail carrier via the material joint to a tool body or to the tool carrier section, respectively, i.e. to form the material joint integrally with the tool carrier section and the guide rail carrier. However, this generally requires a complex setup of the tool carrier section, but which can be provided readily and meanwhile also economically, for example by means of a production of the tool body using 3D printing. An improved flexibility with regard to the design of the material joint, however, results if the component carrying the guide rail carrier via the material joint is formed by a cassette, which is preferably formed in the shape of a cuboid. This results in the further advantage that a seat in the tool carrier section receiving the cassette can be used to provide a directed movability to the material joint.

If the cassette is received in a pocket, for example in a slit-like recess of the tool carrier section and can be fixed therein by means of a clamping screw passing through the cassette, in that it can be pushed under flat support on an essentially radial support surface against a support surface assembly, which runs at an angle thereto, the guide rail carrier in the pocket or in the slit-like recess, respectively, obtains a flat support in the circumferential direction and a guidance in the radial direction. The forces acting on the material joint when using the tool can thus be further limited, whereby more design freedom is created for the material joint.

A suitable radial support of the cassette can simultaneously be used to expand the bandwidth of the resetting movement of the guide rail, namely preferably in that the cassette is held in a radially adjustable manner on the tool carrier section.

Cutting tools are often carried by cassettes, which are fixed into a pocket of the tool carrier section. The cassettes are thereby equipped with cutting material plates. Cassettes of this type can also be equipped with an above-described material joint, which is located behind the blade and via which the guide rail carrier is connected to the cassette. The guide rail can be positioned at a relatively small circumferential distance from the blade of the tool in this way, whereby components can simultaneously be saved.

To specify or to control, respectively, the deformation behavior of the material joint as exactly as possible, an accurately manufactured three-dimensional material bridge is required between the guide rail carrier and the section that is fixed to the tool. This production can take place, for example, by means of a material-removing machining, such as, e.g., by means of an erosion process.

A particularly large flexibility with respect to the design of the material joint is at hand if the material joint is produced by means of the 3D printing process, such as, e.g., using an SLS process.

The above-described material joint can generally be part of a tool or of a tool carrier section, respectively. However, additional production-related advantages follow if the material joint is part of an exchangeable cassette, preferably in the design as essentially prismatic or cuboidal body, respectively, according to claim 14, which, for the fixation to the tool can be pushed with three of its outer surfaces against stops of the tool by means of a clamping screw, and carries a guide rail on a radially outer side surface. In this case, a section of the cassette carrying the guide rail is connected to a section that is fixed to the cassette via the material joint, and the material joint can be blocked by means of the above-discussed setting means. The above-described advantages with regard to the setting and resetting of the guide rail also apply for this design, so that this does not need to be discussed in more detail here.

Advantageous designs of the cassette are subject matter of claims 15 to 22.

To provide for the setting and adjustment of the guide rail within the broadest possible spectrum, it is advantageous when one proceeds as follows: first of all, the guide rail carrier, which is connected via the material joint to the component of the tool, which is spatially fixed or fixable, respectively, with respect to the tool carrier section, is brought into a position by means of the at least one setting member, in which position the radially outer support surface of the guide rail is aligned parallel to the tool axis under small elastic deformation of the material joint, and is essentially flush with the radially outermost cutting circle of the tool blade. The guide rail is then ground to size in this position. From this position, the guide rail can thus be adjusted radially inwards as well as outwards in the micrometer range, namely on both sides of the material joint either in the same or in the opposite direction, whereby a tilt adaptation in the arcminute range is also possible.

Advantageous designs of the invention will be described in more detail below.

### BRIEF DESCRIPTION OF THE FIGURES

FIGS. 1 and 2 are perspective views of a first embodiment of the tool, wherein FIG. 2 is a view corresponding to FIG. 1 in transparent illustration;

FIGS. 3 to 5 are illustrations (perspective, top view, and sectional illustration) of a cassette, which is used in the case of the first embodiment of the tool and which carries a guide rail;

FIGS. 6 to 8 are illustrations (perspective, top view, and sectional illustration) of a variation of the cassette;

FIGS. 9 to 11 are illustrations (perspective with two sectional illustrations) of a variation of the cassette;

FIGS. 12 to 14 are illustrations (perspective, top view, and sectional illustration) of a variation of the cassette with cutting plate;

FIGS. 15 to 22 are illustrations (perspective, perspective transparent, side and rear view, and four sectional illustrations) of a further variation of the cassette with cutting plate;

FIGS. 23 to 25 are illustrations (perspective and two sectional illustrations) of a further variation of the cassette;

FIGS. 26 and 27 are illustrations (perspective and sectional illustration) of a variation of the cassette;

FIGS. 28A to 28G are illustrations of the sequence of production and setting processes of a cassette carrying the guide rail; and

FIG. 29 is a perspective view of a modified design of a guide rail adjustment.

Preferred embodiments of the present invention will be described below on the basis of the corresponding figures. Functionally comparable elements are thereby provided with similar reference numerals, which are preceded by a different ordinal number.

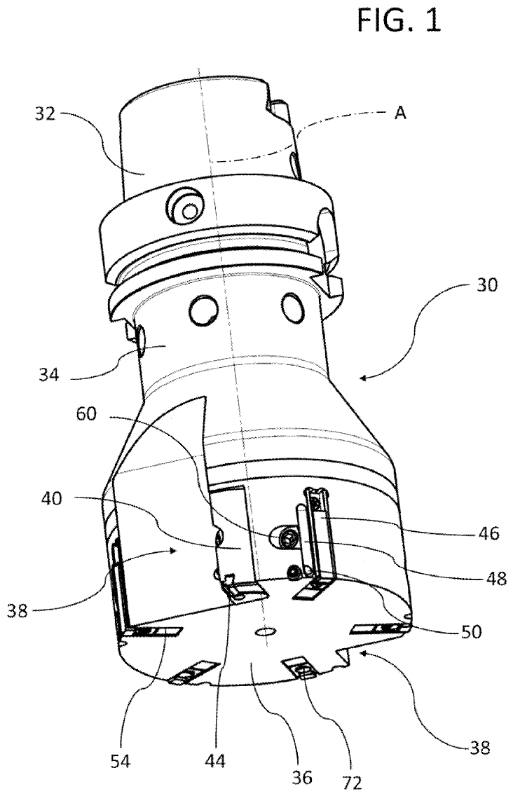

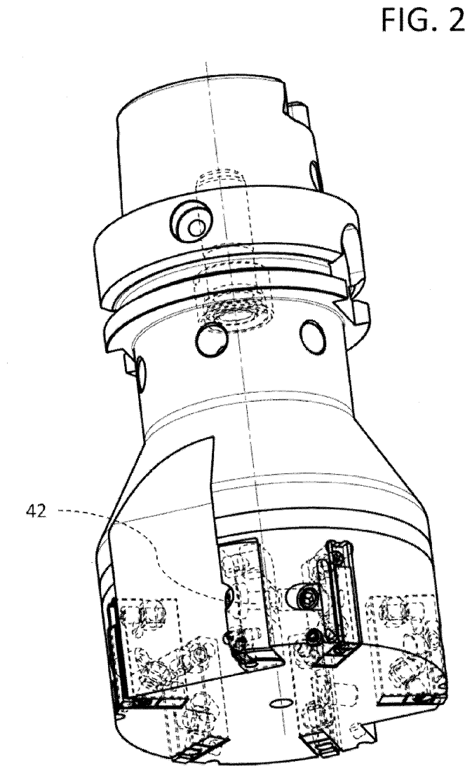

FIGS. 1 and 2 show perspective views of an embodiment of a machining tool 30 according to the invention. The tool can be rotatably driven has a tool axis A. In this example, it serves the purpose of producing a relatively large bore in the magnitude of TO mm with particular surface quality and precision, for example with a diameter tolerance in the micrometer range. For connection to a machine tool spindle, it has an HSK clamping shaft 32 for this purpose, to which a tool head 36 is connected via a relatively short shaft section 34, which tool head is identified hereinafter as tool carrier section and which has several—in the shown case two—pockets 38, distributed over the circumference, for receiving an essentially cuboidal or prismatic blade carrier cassette 40, respectively, which is formed as so-called cartridge. In the shown exemplary embodiment, only one cartridge 40 is provided, which, as can be seen from FIG. 2, is fixed in the pocket 42 by means of a clamping screw 42. The pocket 38 simultaneously serves as chip space. The cartridge 40 can preferably be set radially and/or axially and/or with respect to its tilt to the tool axis A by means of a setting means, which is not illustrated in more detail. On the front side, the blade carrier cassette 40 carries a cutting insert 44 comprising a cutting edge on the front-side and on the circumferential side, so that the tool is front-cutting.

To guide the tool as exactly as possible in the bore, which is to be formed or machined, respectively, and to thus ensure the desired dimensional accuracy and surface quality, has it several—in the shown case five—guide rails 46, which are preferably distributed unevenly over the circumference and which are aligned parallel to the tool axis A and which preferably extend axially all the way to the position of the front-side cutting edge of the cutting insert 42. The guide rails 46, which preferably consist of a hard material, such as, e.g., solid carbide (SC), are precision-ground on the outer side, so that the outer surface thereof, adapted to the cutting forces, supports itself as evenly as possible on the bore wall and thus centers the tool carrier section 36 in the bore. For this purpose, the guide rails 46 can be set or reset, respectively, with respect to their radial position and with respect to their tilt relative to the tool axis A, namely preferably in the micrometer range or in the arcminute range, respectively, which will be described in more detail below with reference to further figures. The guide rails 46 are preferably also included in a coolant/lubricant (CL) supply system, which includes a groove 48, which can be seen in FIG. 1, and a CL outlet opening 50.

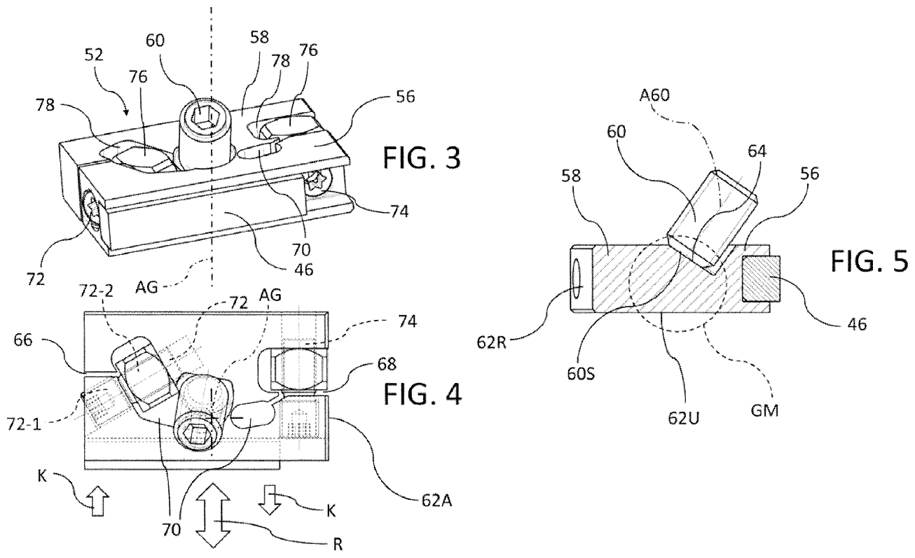

The guide rails 46, in turn, sit on cassettes 52 (see FIGS. 3 to 5), which, in cuboidal design, are received largely in a positive manner in slit-shaped recesses 54 of the tool carrier section 36 and are anchored there. The dimensions of such a cassette 52 lie, for example, at a length of 25 to 35 mm, a depth of 12 to 20 mm, and a thickness of 4 to 8 mm. A setting means, which will be described in more detail below on the basis of FIGS. 3 to 5, serves the purpose of setting the guide rails 46.

The cassette has a guide rail carrier 56, which carries the guide rail 46 in a stationary manner, for example, by means of a solder or adhesive connection and which is connected via a material joint GM, i.e. via a material bridge, which is shown in the sectional illustration according to FIG. 5 and which is identified with dashed lines, to a cassette section 58, which is held positionally securely and so as to be secured against displacement in the slit-like recess 54 by means of a clamping screw 60, which is screwed into the tool carrier section 36, so that this cassette section 58 forms a section that is fixed to the tool. The clamping screw 60 is oriented and passes through the tool carrier section 36 so that it pushes the cassette 52, i.e. the cassette section 58 carrying the guide rail carrier 56, with three side surfaces 62R, 62A, and 62U against a support surface assembly, in the shown example against three support surfaces of the slit-shaped recess 54, which are positioned at an angle, for example at a right angle, to one another. As follows from FIG. 5, the clamping screw 60 is thereby supported with a front side 60S in a flat manner on a pressure surface 64 of the cassette section 58. FIG. 5 thereby shows the section perpendicular to this pressure surface 64 along the axis A60 of the clamping screw 60. The radial support takes place via the side surface 62R, the axial support via the side surface 62A, and the support in the circumferential direction takes place via the side surface 62U.

The material joint GM is created in that material of the cassette 52 is removed on both sides of the material bridge, which takes place, for example, in that a predetermined recess pattern, which can be seen in FIGS. 3 and 4, is introduced into the cassette 52, for example, using the milling and/or erosion process. A configuration is thus created, according to which the guide rail carrier 56 is formed similar to a tipping beam, which is supported essentially centrally on the cassette section 58, and is held thereon. The material joint GM is thus designed in such a way that, under elastic deformation of the material bridge, it allows for an essentially radial displacement movement and a pivoting movement of the guide rail carrier 56, which is stiff compared to the material joint, about an axis AJ (see FIGS. 3 and 4), which is essentially perpendicular on a radial plane containing the guide rail 46 and the tool axis A, thus on the drawing plane of FIG. 4. In the embodiment of FIGS. 3 to 5, the recess pattern has an axial slit 66, 68, which in each case widens into a bulge 70 in the vicinity of the material joint GM on both sides of the material joint GM.

As illustrated in FIGS. 3 and 4, a setting means, by means of which the position and alignment of the guide rail carrier 56 can be changed and the material joint GM can be blocked, engages with the guide rail carrier 56. For this purpose, the setting means has two longitudinally adjustable setting members 72, 74, which are formed in a rod-like manner and which is connected between the guide rail carrier 56 and the cassette section 58, that is, a component of the tool 30, which is spatially fixed or fixable, respectively, with respect to the tool carrier section 36.

As shown in FIGS. 3 and 4, the two identically formed setting members 72, 74 are located on different sides of the material joint GM or of the joint axis AJ, respectively, and they are formed by setting screws, which are preferably accessible radially or on the front side and which are supported on the cassette section 58 on the one hand and are in threaded engagement with the guide rail carrier 56 on the other hand. More precisely, the setting screws 72, 74 are in each case formed by a differential threaded screw, which has two threaded sections 72-1, 72-2 of a different pitch, a first threaded section 72-1 of which is in threaded engagement with the guide rail carrier 56, and a second threaded section 72-2 of which is in threaded engagement with a nut 76, which can preferably be inserted from the outside and which is caught in an axially fixed manner in a slit-like recess 78 of the cassette 52.

The threaded sections 72-1, 72-2 have different diameters in such a way that the threaded section 72-2 of a smaller diameter can be inserted with play through the thread in the guide rail carrier 56, before it comes into engagement with the nut 76. The differential threaded screw 72, 74 is then screwed with its threaded section 72-1 of a larger diameter into the corresponding internal thread in the guide rail carrier 56, until the threaded section 72-1 is received essentially completely in the internal thread of the guide rail carrier 56. So that the threaded section 72-2 can simultaneously also be screwed into the nut 76 essentially to the same extent with different thread pitch during this screw-in movement, without applying an external force to the material joint GM, the nut 76 is turned in order to compensate for the threaded pitch difference.

In the assembly situation shown in FIGS. 3 and 4, a drive movement of the differential threaded screw 72, 74 has the result that the guide rail carrier 56 is moved either towards the cassette section 58 or away from it under elastic deformation of the material joint GM, so that the guide rail carrier 56 and thus the guide rail 46 can be radially displaced and/or tilted, as suggested by means of the double arrow R in FIG. 4, which is suggested by means of the arrow pair K in FIG. 3. The guide rail carrier 56 supports itself continuously and in a flat manner via its side wall 62U on the support surface in the slit-like recess 54 in the tool carrier section 36 during this setting or resetting movement, respectively, whereby the material joint is subject to a bending deformation, which is limited to one plane. The adjustment or resetting, respectively, of the guide rail 46, which is made possible thereby, lies in the micrometer or arcminute range, respectively.

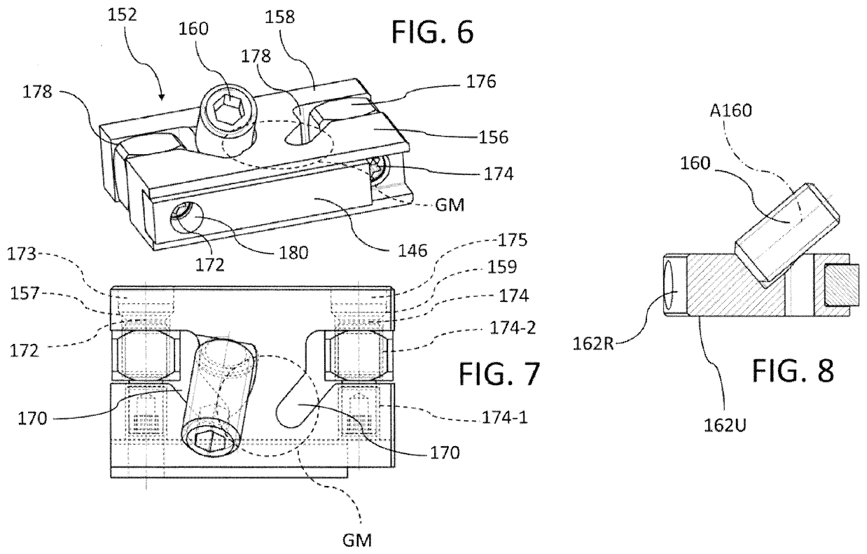

A special feature of the embodiment according to FIGS. 1 to 5 is to be seen in that one of the setting screws, i.e. the setting screw 72, can be actuated from the front side of the tool 30. The variation of the cassette 152 according to FIGS. 6 to 8 already differs from the exemplary embodiment described above in that both setting screws 172, 174 can be adjusted radially from the outside, i.e. from the side of the guide rail 146. The anchoring of the cassette 152 on the tool carrier section 36 of the tool takes place in the same way as in the case of the exemplary embodiment of FIGS. 3 to 5, so that a description can be forgone.

The guide rail 146, which is soldered or adhered into the guide rail carrier 156, has an axial length, which corresponds essentially to the axial length of the guide rail 46, so that the cassette 152 is also suitable for equipping a front-cutting tool. However, the guide rail 146 has to additionally be equipped with an aperture 180 for a setting tool for actuating the setting screw 172. The material joint GM suggested in FIGS. 6 and 7 by means of a dashed line between the guide rail carrier 156 and the cassette section 158 is created by means of clearance millings 170, which connect to lateral pockets 178 for receiving the nuts 176 in an axially fixed manner.

The setting screws 172, 174, which—like in the case of the exemplary embodiment according to FIGS. 3 to 5—are formed as identical differential threaded screws, differ from the setting screws 72, 74 of FIGS. 3 to 5 in that they are inserted or threaded, respectively, from the other side of the cassette, thus from the side facing away from the guide rail 146. A threaded section 174-2 with a larger diameter is thus in threaded engagement with the nut 176, while a threaded section 174-1 with a different thread pitch and a smaller diameter is in threaded engagement with the guide rail carrier 156. The outer diameter of the threaded section 174-1 is smaller here than the inner diameter of the thread in the groove 176. Both differential threaded screws 172, 174 in each case have a screw head 173, 175 with an increased diameter, whereby, in cooperation with a shoulder 157, 159 of the respective receiving bore, a rotational movement stop for the differential threaded screws 172, 174 is formed in the cassette section 158.

A stop position for the radial displacement of the guide rail 146 is also created in this way.

A setup, in the case of which the guide rail carrier 156 is connected via a material bridge forming the material joint GM to the remaining part of the cassette 152, thus to the cassette section 158, is thus also present in the case of this exemplary embodiment. The material joint GM is thereby designed so that it provides a directed elastically floating movability to the guide rail carrier 156 in a plane, which runs parallel to the side surface 162U.

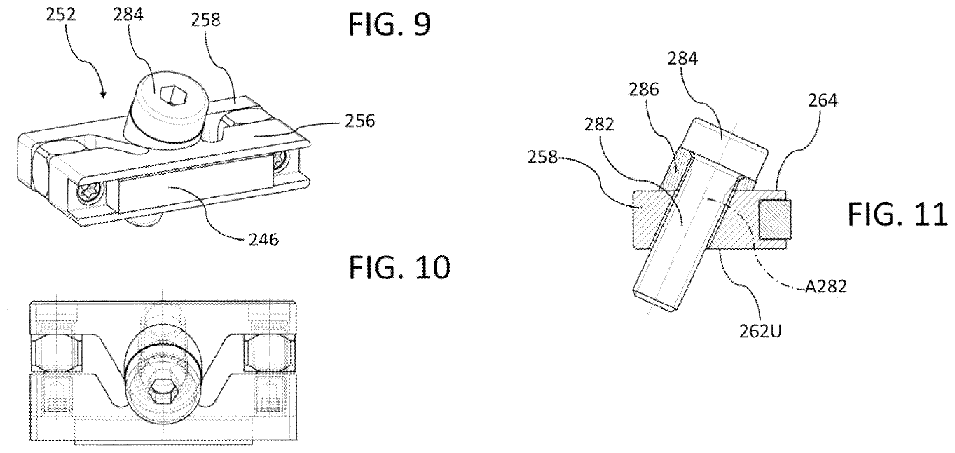

A further embodiment of cassette 252 carrying a settable guide rail 246 is illustrated in FIGS. 9 to 11. With regard to the formation of a material joint GM between the guide rail carrier 256 and the cassette section 258, which can be firmly secured to a tool carrier section 36, and the setting technique, there are no significant differences compared to the exemplary embodiment according to FIGS. 6 to 8, so that a description can be omitted here.

The cassette 252 is suitable for the use on tools, which are not front-cutting. The axial shortening of the guide rail 246 and the way in which the cassette 252 is fixed in the slit-like recess of the tool carrier section 36 differ from the design according to FIGS. 6 to 8. A clamping screw 282 is used for this purpose, which passes through the cassette section 258 with play and which is screwed into the tool carrier section 36, wherein a screw head 284 is supported in a flat manner on a spacer sleeve 286 and pushes the latter in a flat manner against a side surface 264, which faces away from the side surface 262U. The spacer sleeve 286 is thus beveled in accordance with the tilt of the axis A282 of the clamping screw 282.

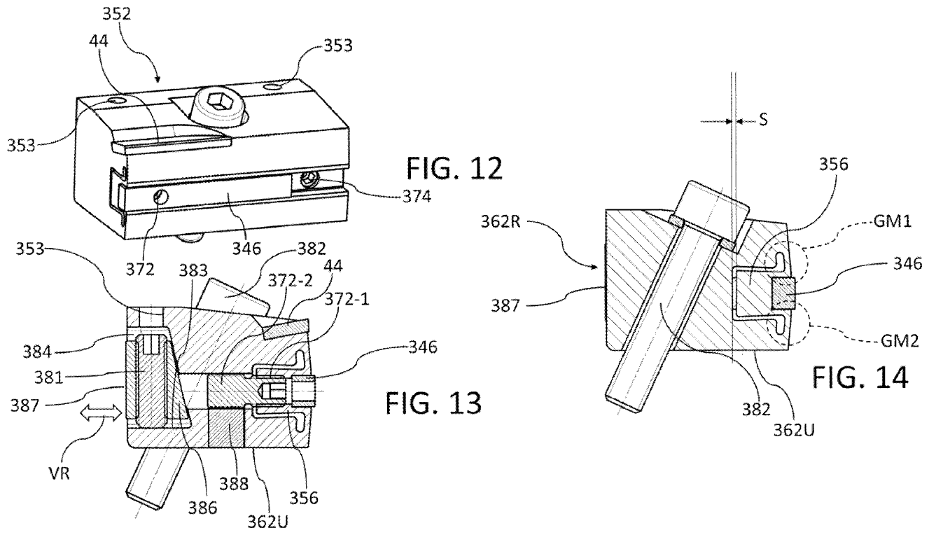

With reference to FIGS. 12 to 14, a further modified embodiment of a cassette will be described below, which is formed as a cartridge 352 carrying a cutting plate 44 with integrated guide rail 346. The cartridge 352—like the cartridge 40 in FIG. 1—which is formed essentially in the shape of a cuboid is clamped tightly in a pocket of the tool by means of the clamping screw 382, so that it comes into engagement with its outer surface 362U, which is located perpendicular to the circumferential direction, with a counter stop surface of the tool carrier section 36. The radially inner side 362R is simultaneously pushed against a corresponding counter stop surface of the tool carrier section 36.

So that the cartridge 352 also becomes adjustable in the radial direction, support bodies 386 are received on the side facing away from the guide rail 346 in correspondingly molded or milled-out pockets 384, which support bodies are radially supported via a wedge surface pairing in the pockets 384 and which each form a support surface 387 on the side facing away from the guide rail 346—as can be gathered best from the sectional view according to FIG. 13. To set or to adjust, respectively, the support surfaces 387 in the radial direction—as suggested by means of the double arrow VR in FIG. 13—an adjusting screw 381 is provided, which is screwed into the support body, which is axially supported on a bottom surface 383 of the pocket 384 and which can be actuated via a profile recess on the opposite side by means of a suitable tool. Sufficiently large apertures 353 are provided in the cartridge 352 for the pass-through of such a tool. It can be seen from the illustration according to FIG. 13, which illustrates the sectional view of the cartridge 352 in the region of the aperture 353, that the support body 386 can be moved to the top and to the bottom by means of a rotational movement of the adjusting screw 381, whereby the support surface 387 and thus the cartridge 352, when the clamping screw 382 is loosened, radially shifts on the tool carrier section. Not only the radial position of the cutting edge of the cutting plate, but also the positioning thereof to the tool axis can thus be set.

As in the above-described exemplary embodiments, the cartridge 352 is equipped with a settable guide rail 346, which sits on a guide rail carrier 356. The guide rail carrier 356 is connected to the main body of the cartridge 352 via a material joint GM, more precisely via the material bridges JM1 and JM2 (see FIG. 14 with the view of the section in the region of the clamping screw 382), so that it can be set radially and with respect to its tilt to the tool axis A or to the support surface 387, respectively, under elastic deformation of the material bridges JM1 and JM2. A sufficiently wide gap of the size S (see FIG. 14), which specifies the maximum adjustment path of the guide rail 346, remains between the guide rail carrier 356 and the main body 358 of the cartridge 352.

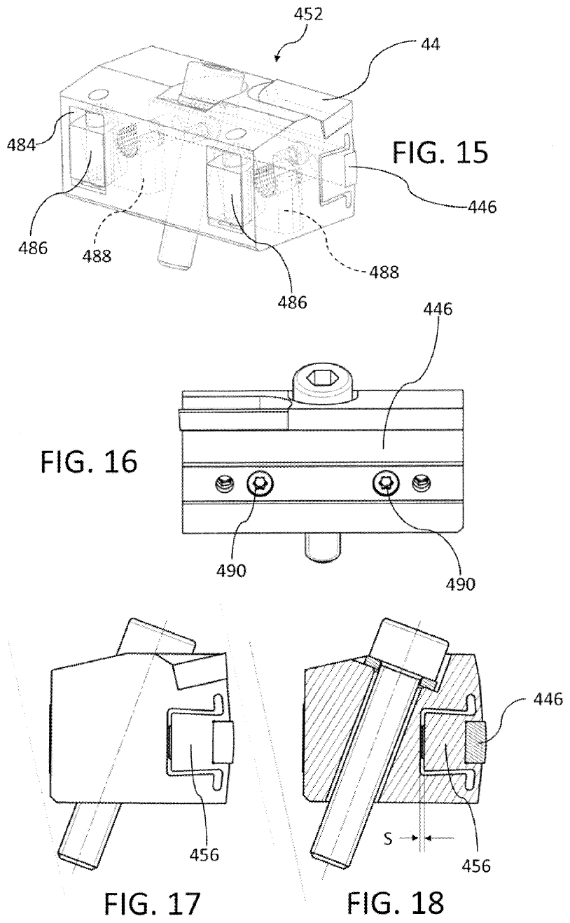

Two differential threaded screws 372, 374, which are offset axially from one another and which can be actuated radially from the outside, one of which is shown in the section according to FIG. 13, are again provided for setting or resetting, respectively, the guide rail 346. The differential threaded screw 372, which can be inserted into the cartridge 352 from the side facing away from the guide rail 346 via a bore, which is not identified in more detail, is screwed with its threaded section 372-1 of a smaller diameter into the guide rail carrier 356 and with its threaded section 372-2 of a larger diameter is in threaded engaged with a support nut 388, which can be inserted from the bottom side of the cartridge 352 in the case of assembled, i.e. screwed-in position of the differential threaded screw 372 (see FIG. 13), so that it sits immovably and flush with the outer surface 362U in the cartridge 352 with fit. The support nut 388 is thereby formed so that its thread encompasses the threaded section 372-2 only over a central angle of 180°, thus up to a central plane PC of the differential threaded screw 372. This detail can be gathered best from FIG. 15, which will be described below.

For the pass-through of an adjusting tool engaging with the head of the differential threaded screw 372, the guide rail 346 has an aperture 380. As in the case of the above-described exemplary embodiments, the guide rail can be adjusted parallel to the tool axis A or to the outer wall 362R, respectively, radially inwards and outside as well as with respect to its tilt to these reference lines and surfaces, by rotating the differential threaded screws 372, 374, whereby this adjustment can be effected with an accuracy in the micrometer or arcminute range, respectively. The adjustment of the guide rail carrier 356 to the body of the cartridge 352 that is fixed to the tool is thereby in line with the gap of the width S (FIG. 14).

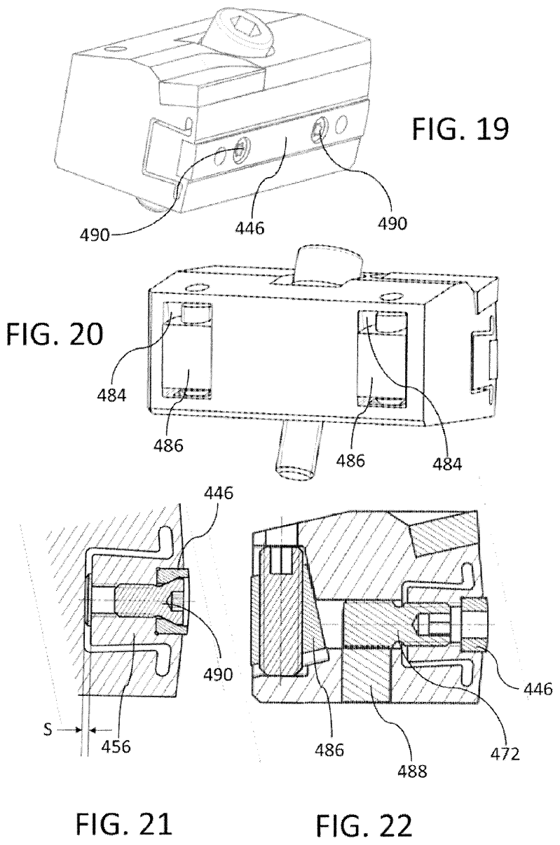

A design, which is modified slightly compared to an exemplary embodiment according to FIGS. 12 to 14, of a cartridge 452, which is equipped with a cutting insert 44, comprising an integrated adjustable guide rail 446, is described with reference to FIGS. 15 to 22. The individual figures show: a perspective view of the cartridge 452 in FIG. 15; a side view in the case of a viewing direction parallel to the plane of the cutting insert 44 in FIG. 16; a side view in the case of a viewing direction parallel to the tool axis in FIG. 17; the sectional view in a plane through the axis of the clamping screw in FIG. 18; the perspective view of the cartridge, viewed from the radial outer side, in FIG. 19; the perspective view of the cartridge, viewed radially from the inside, in FIG. 20; the slightly enlarged partial section in the region of a fastening screw 490 for the guide rail 446 in FIG. 21, and the section in the region of a differential threaded screw 472 for setting or adjusting, respectively, the guide rail 446, in FIG. 22.

There are conformities with the design of the cartridge according to FIGS. 12 to 14 with regard to the design of the material joint, the radial settability of the cartridge 452, and the radial settability and resettability of the guide rail 446, so that a repeated description can be omitted. The components required for this are provided with similar reference numerals, but which are preceded by a “4” instead of a “3”.

In contrast to the formation of the cartridge according to FIGS. 12 to 14, a guide rail 446 is present in the case of the exemplary embodiment of FIGS. 15 to 22, which extends over the entire length of the cartridge 452. The guide rail 446 is additionally releasably screwed to the guide rail carrier 456 by means of two fastening screws 490 (see FIG. 21). Details of the components can be seen from FIG. 15, which have already been mentioned above to describe the radial adjustment of the cartridge and of the setting of the guide rail. The pockets 484, which are incorporated or molded into the cartridge 452 for the positive reception of the support bodies 486 and the design of the support nut 488, which is in threaded engagement with the threaded section 472-2 of the differential threaded screw 472 only via a central angle of 180°, can be seen in detail. The material bridges JM1 and JM2 are formed exactly like in the case of the exemplary embodiment according to FIGS. 12 to 14. To produce material bridges of this type, an erosion or a laser machining process can be used, for example.

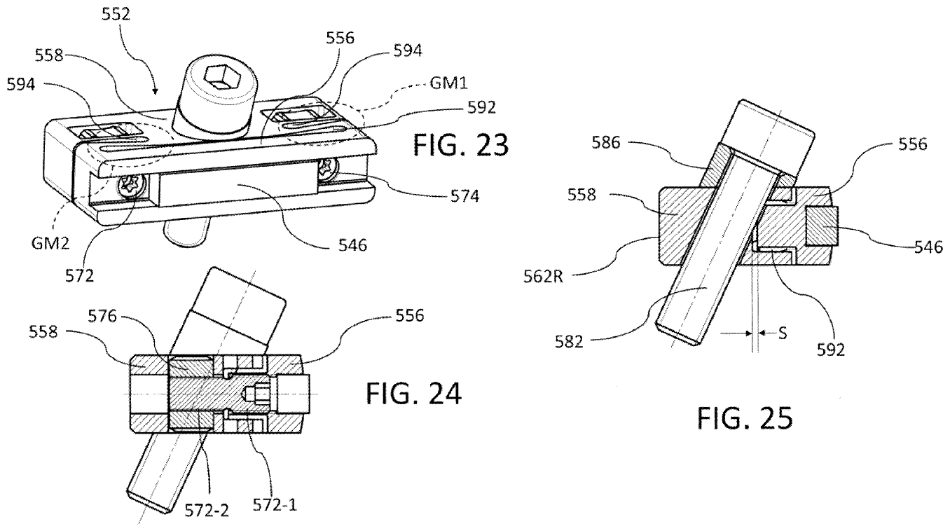

A further design of a cassette 552, which carries the settable guide rail 546, is described in more detail with reference to FIGS. 23 to 25. With regard to the radial adjusting technique, this embodiment does not differ significantly from the embodiment of FIGS. 6 to 8 and of FIGS. 9 to 11, but with the difference that the differential threaded screws 572, 574 are screwed or threaded, respectively, into the cassette 552 from the outside, so that threaded section 572-1, which has a larger diameter, is in threaded engagement with the guide rail carrier 556 as in the case of the exemplary embodiment according to FIGS. 3 to 5, while the other threaded section 572-2, which is equipped with a different thread pitch and which has a smaller diameter, engages with a nut 576, which is caught in a non-displaceable manner in a recess of the cassette section 558.

A significant difference to the above-described variations can be seen in the design of the material joint, i.e. in the design of the material bridges JM1, JM2, which are identified by means of dashed lines in FIG. 23, via which the guide rail carrier 556 is connected to the cassette section 558. These material bridges are created in that a multi-dimensional recess 592 (see FIGS. 23 and 25), which extends almost over the entire length, is molded or incorporated into the cassette body, whereby lateral notches 594 are additionally provided, so that material webs 596 remain between guide rail carrier 556 and cassette section 558, which can be elastically deformed by means of the differential threaded screws 572, 574 in order to set the guide rail 546 radially and/or with respect to its tilt to the tool axis or to the outer surface 562R, respectively. In the case of this variation, the guide rail carrier 556 also supports itself in a flat manner with the tool carrier section due to the bracing of the cassette section 558, so that the material joint JM1, JM2 has to be blocked only in one plane by means of the differential threaded screws 572, 574.

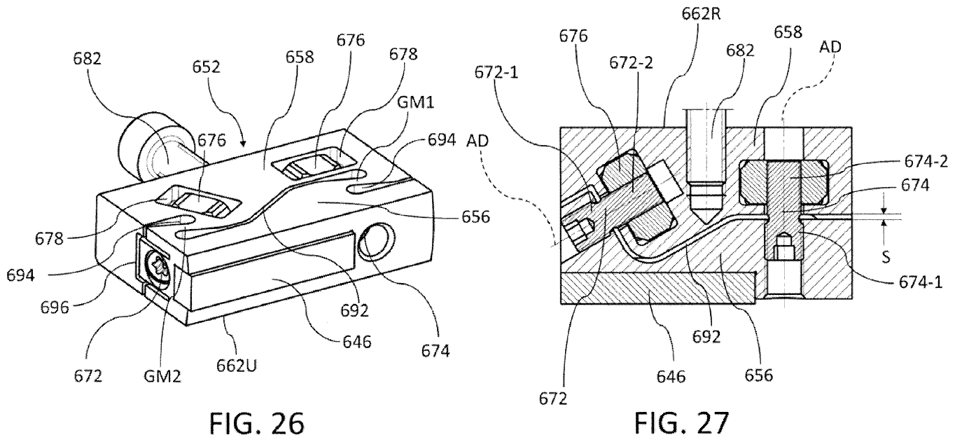

Lastly, an embodiment, which is modified with respect to the design of the material joint GM and with respect to its anchoring on the tool carrier section, of a cassette 652 formed in the shape of a cuboid, with integrated settable guide rail 646 is described with reference to FIGS. 26 and 27. Apart from that, the cassette 652, including the actuation and accessibility of the differential threaded screws 672, 674 corresponds to the embodiment shown in FIGS. 3 to 5, so that a repeated description of the components required for this purpose and the mode of operation thereof can be omitted. Comparable components are provided with reference numerals again, which are similar to those of FIGS. 3 to 5, but which are preceded by a “6”.

Instead of a clamping screw, which obliquely penetrates the cassette section 858, as it is used in the case of the embodiments of FIGS. 9 to 25, a draw-in screw 682 is used in the case of the exemplary embodiment according to FIGS. 26 and 27, in order to push the cassette section 658 with the outer surface 662R thereof against a support surface in the recess 54 of the tool carrier section 36, and to thus position it so as to be fixed to the tool.

As in the case of the embodiment according to FIGS. 3 to 5, the identically formed differential threaded screws 672, 674 are accessible and adjustable from the front side (672) and the radial outer side, so that the guide rail 646 can be formed without aperture for one of the differential threaded screws 672, 674. As can be gathered from the sectional illustration according to FIG. 27, which shows the horizontal section at the height of the axes AD of the differential threaded screws 672, 674, the threaded sections 672-1, 674-1 with a larger diameter engage with the guide rail carrier 656, while the threaded sections 672-2, 674-2 with a larger diameter are in each case screwed into a nut 676, which is caught in an axially non-displaceable manner in a pocket 678 of the cassette section 658, which can be firmly fixed to the tool carrier section.

The guide rail carrier 656 is connected to the cassette section 658 via a material joint, which is formed symmetrically to the sectional plane of FIG. 27 and which—as can be gathered from the illustrations of FIGS. 26 and 27—is formed in a relatively complex manner, thus a 3D printing process, as it is used, e.g., in a selective laser sintering (SLS) process, is preferably used for the formation. It is significant that the material joint is formed by means of geometrically predetermined material cut-out regions, which are identified with reference numerals 692, 694, and 696, in such a way that elastically resilient material bridges JM1, JM2 and a sufficiently large gap of the width S remains between the cassette section 658 and the guide rail carrier 656, by means of which it is made possible to the guide rail carrier 656 to move relative to cassette section 658 radially inwards at least in line with the gap S in a plane parallel to the bottom surface 662U, via which the cassette 652 supports itself in a slit-like recess 54 of a tool carrier section 36, as shown in FIGS. 1 and 2, when the differential threaded screws 672, 674 are adjusted. The radial position of the guide rail 646 as well as the angular position thereof to the cassette section 658 and thus to the tool axis A can be set in this way.

To largely rule out a bending deformation of the guide rail carrier 656 thereby, the material joint formed by the remaining material bridges JM1, JM2 is designed to be sufficiently soft, compared to the guide rail carrier 656. An excessive stress is avoided in that the radial forces acting on the guide rail 646 are absorbed by the differential threaded screws 672, 674, and the forces, which are introduced by the guide rail in the circumferential direction, are caught by means of the flat support of the guide rail carrier 656 via the bottom surface 662U thereof. The differential threaded screws 672, 674 can thus also be formed with a relatively small volume.

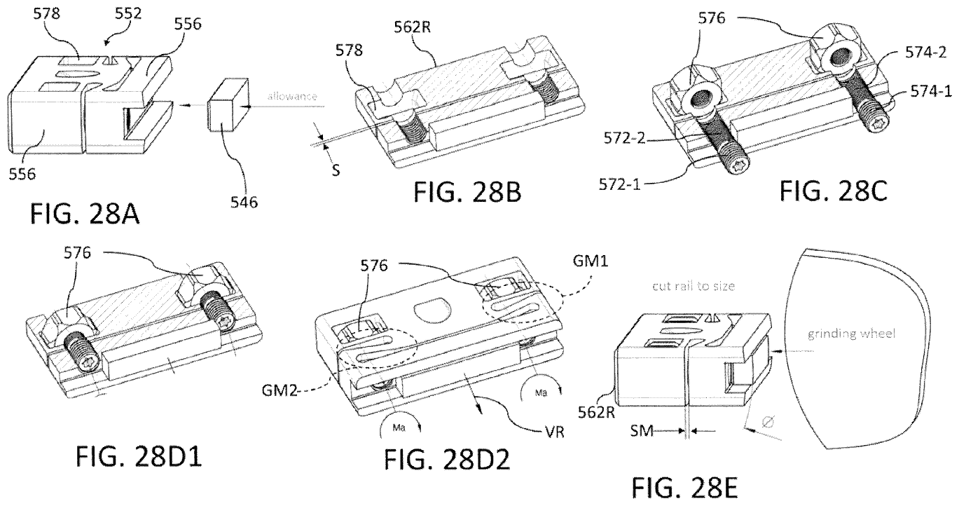

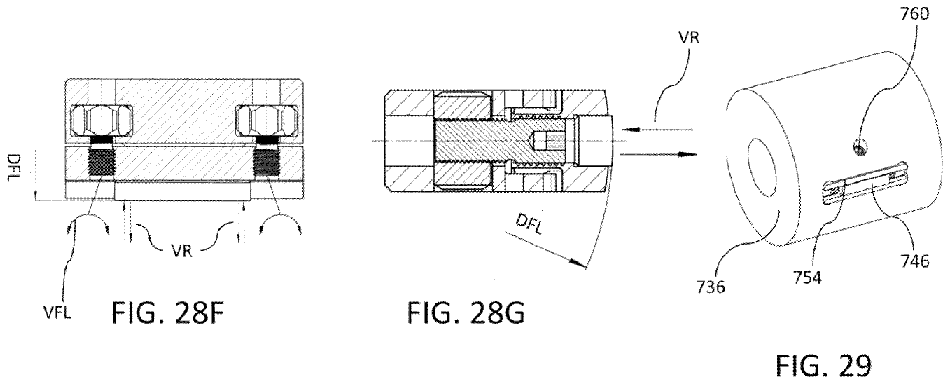

It will be described on the basis of FIGS. 28A to 28G below, how the guide rails, which are used in the case of the above-described cassettes, are preferably assembled on the tool, on the cassettes, and on the cartridges. A cassette construction according to FIGS. 23 to 25 is used thereby, for example, so that the reference numerals used there are also adopted.

The finish-machined cassette 552, which is equipped with the threaded bores, pockets, and material joints or material bridges JM1, JM2, respectively, and which has been produced, for example, using a 3D printing process, is initially equipped with a guide rail 546 (FIG. 28A), which also has a radial allowance. The guide rail 546 is thereby soldered, for example, into the guide rail carrier 556.

The assembled guide rail, which lie laterally next to the threaded bores in the guide rail carrier 556 serve the purpose of receiving the differential threaded screws 572, 574, is shown in the sectional view according to FIG. 28B.

As illustrated in FIG. 28C, the nuts 576 are now inserted into the recesses 578 of the cassette section 558, whereupon the differential threaded screws 572, 574 can be inserted with their threaded sections 572-2, 574-2 of a smaller diameter with play through the threaded bore in the guide rail carrier 556, until a threaded section 572-1, 572-2, 574-1, 574-2 comes into engagement with the counter thread in the guide rail carrier 556 or in the cassette section 658.

The differential threaded screws can now initially be screwed without force into a position shown in FIG. 28D1. Due to the fact that the threaded sections 572-1 and 572-2 or 574-1 and 547-2, respectively, have a different thread pitch, the nut 576 has to initially also be rotated during the screw-in movement, in order to compensate for the pitch difference. The differential threaded screws can thus be brought into the position shown in FIG. 28D1, without stressing the material bridges JM1, JM2. The guide rail carrier 556 is connected to the guide rail carrier 558 without force, but so as to be reinforced via the differential threaded screws 572, 574.

The nuts 576 are held in a rotationally fixed manner in this position of the differential threaded screws 572, 574. When the differential threaded screws 572, 574 are now further rotated, the guide rail carrier 556 is moved away from the cassette section 558 under elastic deformation of the material bridges JM1, JM2—as suggested in FIG. 28D2 by means of the arrow VR—so that the gap width S (see FIG. 28B) increases. It has been shown that for the parallel adjustment of the guide rail carrier 556, it is advantageous to tighten the differential threaded screws 572, 574 by means of a torque wrench up to a limit tightening torque Ma. The size of the torque Ma depends on the design of the material bridges JM1, JM2 and the stiffness of the guide rail carrier 556; in the case of the cassettes shown in the figures, it lies in the order of 1 Nm. The gap width S between guide rail carrier 556 and cassette section 858 has thereby increased to a value SM, as shown in FIG. 28E.

In this position, thus in an alignment parallel to the outer surface 562R facing away from the guide rail 556 or parallel to the tool axis A, respectively, the guide rail 546 is cut to size—as illustrated in FIG. 28E—i.e. round-ground to size by means of a grinding wheel when the cassette 578 is firmly anchored on the tool carrier section, so that it is essentially flush with the radially outermost cutting circle of the tool blade of the tool.

From this position, the guide rail 556 can then be adjusted radially inwards and outwards by the measure SM, uncoupled on both ends and from one another, as suggested in FIG. 28F, for the fine setting or for the resetting, respectively, in that the differential threaded screws 572, 574 are rotated in one of the two directions, as suggested by means of the double arrows VFL, whereby the diameter DFL, on which contact surface of the guide rail 546 lies, or the tilt angle of the guide rail to the tool axis, respectively, can be set or reset, respectively, in the accuracy range of micrometers or arcminutes, respectively.

FIG. 29 shows a modified manner of the guide rail adjustment. The guide rail 746 sits on a cassette 752, which can be formed similar to the cassette 552 of FIGS. 23 to 25 with respect to the material joint and the adjusting technique by means of the differential threaded screws, but which has a modified anchoring in the tool carrier section 736, which is illustrated in a stylized manner. The cassette is received in a positive manner in a pocket 754 and is fixed in the pocket 754 by means of a pressure screw 760—similar as in the case of the embodiment according to FIGS. 3 to 5.

It goes without saying that further modifications of the above-described embodiments are possible, without leaving the basic idea of the invention.

Exemplary embodiments have been described above throughout, in the case of which the guide rail carrier is connected via the material joint to a cassette, which, in turn, is fastened to a tool carrier section. However, it is generally also possible to form the recess patterns for forming the material joint in the tool carrier section itself, but which generally requires a special production technique. By means of a suitable additive manufacture, for example by means of an SLS (selective laser sintering) process, however, any design of the material joint can meanwhile also be formed integrally with the tool carrier section in an economic manner.

It is further possible to also form the material joint so that it provides the guide rail carrier with further degrees of freedom of movement, for example a pivoting movement about an axis parallel to the guide rail, which are blocked by the setting means.

The radial setting of the cassette can also be provided in the case of a cassette without cutting insert.

The design of the setting and resetting of the guide rail is also suitable to a particularly extent for tools, by means of which deep bores are to be produced.

The invention thus creates a machining tool for producing or machining bores, respectively, with high positional and/or surface quality, comprising a tool axis and a tool carrier section, which carries at least one tool blade and at least one guide rail, which radially supports the tool carrier section on a bore wall. The guide rail can be set with respect to its radial position and with respect to its tilt relative to the tool axis by means of a setting means, which engages with a guide rail carrier. In order to put together a tool, which operates highly precisely, comprising at least one guide rail, which can be brought into an optimal position quickly and accurately and which can be recalibrated exactly in the case of wear, with little effort, the guide rail carrier is connected via a material joint to a section that is fixed to the tool, thus either to the tool carrier section or a component, which can be firmly connected thereto, such as, e.g. a cassette, and the material joint can be blocked by means of the setting means.

1. A machining tool for producing or machining bores, respectively, with high positional and/or surface quality, comprising a tool axis and a tool carrier section, which carries at least one tool blade and at least one guide rail, which radially supports the tool carrier section on a bore wall and which can be set with respect to its radial position and with respect to its tilt relative to the tool axis by means of a setting means, which engages with a guide rail carrier, the guide rail carrier connected via a material joint to a section that is fixed to the tool, and the material joint can be blocked by means of the setting means.

2. The tool according to claim 1, wherein the setting means has at least one setting member, the length of which can be set and which is formed in a rod-like manner.

3. The tool according to claim 1, wherein the setting means, is connected between the guide rail carrier and a component of the tool, which is spatially fixed or fixable, respectively, with respect to the tool carrier section.

4. The tool according to claim 1, wherein the material joint is designed in such a way that it allows for an essentially radial displacement movement and a pivoting movement of the guide rail carrier with respect to the section that is fixed to the tool about a joint axis, which is essentially perpendicular to a radial plane containing the guide rail and the tool axis.

5. The tool according to claim 4, wherein at least two setting members are provided for blocking the material joint, which lie on different sides of the joint axis.

6. The tool according to claim 2, wherein the at least one setting member has a setting screw, which is supported at least indirectly on the section that is fixed to the tool on the one hand and is in threaded engagement with the guide rail carrier on the other hand.

7. The tool according to claim 6, wherein the setting screw is formed by a differential threaded screw, which has two threaded sections of different pitch or different thread direction, a first threaded section of which engages with the guide rail carrier and a second threaded section of which engages with a nut, which is caught in a non-displaceable manner in a slit-like recess.

8. The tool according to claim 3, wherein the component carrying the guide rail carrier via the material joint is formed by a section of a cassette.

9. The tool according to claim 8, wherein the cassette is received in a pocket, and can be fixed therein by means of a clamping screw either passing through or pushing through the cassette, in that it can be pushed under flat support of a cassette wall on an essentially radial support surface against a support surface assembly, which runs at an angle thereto.

10. The tool according to claim 8, wherein the cassette can be radially adjusted.

11. The tool according to claim 8, wherein the cassette carries at least one cutting tool, which is preferably formed by a cutting plate.

12. The tool according to claim 1, wherein the material joint is produced by means of a material-removing machining.

13. The tool according to claim 1, wherein the material joint is produced using a 3D printing process.

14. A cassette for a machining tool according to claim 1, in the design as essentially prismatic or cuboidal body, respectively, which, for the fixation to the tool can be pushed with three of its outer surfaces against corresponding stops of the tool by means of a clamping screw, and carries a guide rail on a radially outer side surface, a section of the cassette carrying the guide rail is connected to a section that is fixed to the cassette via a material joint, and the material joint can be blocked by means of a setting means.

15. The cassette according to claim 14, wherein the setting means has at least one setting member, the length of which can be set and which is formed in a rod-like manner.

16. The cassette according to claim 14, wherein the material joint is designed in such a way that it allows for a displacement and pivoting movement located parallel to a bearing surface of the cassette, of the section carrying the guide rail with respect to the section that is fixed to the cassette.

17. The cassette according to claim 16, wherein at least two setting members are provided for blocking the material joint, which lie on different sides of a joint axis, which is perpendicular to the bearing surface.

18. The machining tool according to claim 2, wherein the at least one setting member has a setting screw, which can be accessed from an outer surface of a cassette and which is supported at least indirectly on a section that is fixed to the tool on the one hand and which is in threaded engagement with a section carrying the guide rail on the other hand.

19. The matching tool according to claim 18, wherein the setting screw is formed by a differential threaded screw which has two threaded sections of different pitch or different thread direction, a first threaded section of which engages with the section carrying the guide rail and a second threaded section of which engages with a nut, which can be inserted from the outside and which is caught in a non-displaceable manner in a slit-like recess.

20. The cassette according to claim 14, wherein the cassette carries at least one cutting tool.

21. The cassette according to claim 14, wherein the cassette and/or the material joint is produced by means of a material-removing machining.

22. The cassette according to claim 14, wherein the cassette and/or the material joint is produced using a 3D printing process.

23. A method for setting the position and alignment of a guide rail of a machining tool according to claim 1, wherein the guide rail carrier, which is connected via the material joint to a component of the tool, which is spatially fixed or fixable, respectively, with respect to the tool carrier section, is brought into a position by means of at least one setting member, in which position a radially outer support surface of the guide rail is aligned parallel to a tool axis under small elastic deformation of the material joint, and is essentially flush with a radially outermost cutting circle of the tool blade, and that the guide rail is round-ground to size in this position.
